(19) United States
(12) Patent Application Publication
(10) Pub. No.: US 2026/0158385 A1
(43) Pub. Date: Jun. 11, 2026

(54) NOTIFICATION SYSTEM AND NOTIFICATION METHOD

(71) Applicant: Cygames, Inc., Tokyo (JP)

(72) Inventor: Shuichi Kurabayashi, Tokyo (JP)

(73) Assignee: Cygames, Inc., Tokyo (JP)

(21) Appl. No.: 19/182,012

(22) Filed: Apr. 17, 2025

Related U.S. Application Data
(63) Continuation of application No. PCT/JP2023/036695, filed on Oct. 10, 2023.

(30) Foreign Application Priority Data
Oct. 18, 2022 (JP) 2022-166714

(51) Int. Cl. A63F 13/533; A63F 13/35; H04M 1/72427

(52) U.S. Cl. CPC A63F 13/533; A63F 13/35; H04M 1/72427

(57) ABSTRACT

A notification system includes: a game server that generates, when a piece of idle content for giving a reward to a user in accordance with an idle time during which an operation is not performed is started in an electronic device, a schedule for giving the reward; and a notification server that performs notification for displaying information related to the reward in a display area of the electronic device, according to the schedule.

### TECHNICAL FIELD

The present invention relates to a notification system and a notification method.

### BACKGROUND ART

In an electronic device such as a smartphone, various kinds of application programs (hereinafter, abbreviated as “apps”) are operated, and processing results for apps used by a user are displayed on a display unit of the smartphone. While the user does not use the smartphone, a lock screen is displayed on the display unit in order to prevent an operation performed by another user. The lock screen is one of security functions of the smartphone that prevents use of the smartphone unless a specific authentication operation (passcode input, face authentication, or the like) is performed when the user resumes using the smartphone.

In the lock screen, widgets are provided that are capable of displaying information on the home screen or the lock screen without the user activating individual apps. By viewing the widgets, the user can check information (part of an email etc.) displayed on the home screen or the lock screen.

Patent Literature 1 describes that “while a new notification containing content is being displayed, when a drag gesture to a touch-sensitive display is detected, a notification list including a plurality of notifications and the new notification is displayed together with content received from an app, and the user is allowed to scroll the displayed notification list while the electronic device is operated in the lock state”.

### CITATION LIST

### Patent Literature

[PTL 1] Japanese Unexamined Patent Application, Publication No. 2022-106824

### SUMMARY OF INVENTION

### Technical Problem

Pieces of content are provided that enable a user to play games on a smartphone by operating the smartphone. In such pieces of content, in addition to pieces of content in which games progress with user's operations, there are pieces of content in which games progress even in an idle state with no user's operations (hereinafter, referred to as “idle content”). After the user activates a piece of idle content, while the idle content is being idled, a character in the game can obtain an in-game currency and can raise the level of the character. Conventionally, while a piece of idle content is being executed in a smartphone, the user cannot check the progress result of the game app of the idle content unless the user unlocks the lock screen. Thus, after the user starts the idle content, it is cumbersome for the user to perform an operation for unlocking the lock screen every time the user checks how much reward has been obtained.

The present invention has been made in view of such circumstances, and an object thereof is to display information related to rewards for a piece of idle content in a display area of an electronic device.

### Solution to Problem

The present invention provides a notification system including: a game server that generates, when a piece of idle content for giving a reward to a user in accordance with an idle time during which an operation is not performed is started in an electronic device, a schedule for giving the reward; and a notification server that performs notification for displaying information related to the reward in a display area of the electronic device, according to the schedule.

### Advantageous Effects of Invention

According to the present invention, when a piece of idle content is started in an electronic device, notification is performed for displaying information related to rewards in a display area of the electronic device.

Problems, configurations, and effects other than those described above will be clarified by a description of the following embodiment.

### BRIEF DESCRIPTION OF DRAWINGS

FIG. 1 is an overall configuration diagram showing the outline of a notification system according to one embodiment of the present invention.

FIG. 2 is a view showing a display example (1) of a reward notification screen overlaid on a lock screen of a client terminal in the notification system according to the embodiment of the present invention.

FIG. 3 is a block diagram showing an example hardware configuration of a game server in the notification system according to the embodiment of the present invention.

FIG. 4 is a block diagram showing an example hardware configuration of the client terminal in the notification system according to the embodiment of the present invention.

FIG. 5 is a block diagram showing example functional configurations of a game management system and the client terminal in the notification system according to the embodiment of the present invention.

FIG. 6 is a sequence diagram showing example processing procedures in a client side and a server side in the notification system according to the embodiment of the present invention.

FIG. 7 is a view showing a display example (2) of a reward notification screen overlaid on the lock screen of the client terminal in the notification system according to the embodiment of the present invention.

FIG. 8 is a view showing a display example (3) of a reward notification screen overlaid on the lock screen of the client terminal in the notification system according to the embodiment of the present invention.

FIG. 9 is a view showing a display example (4) of a reward notification screen overlaid on the lock screen of the client terminal in the notification system according to the embodiment of the present invention.

### DESCRIPTION OF EMBODIMENTS

An embodiment for implementing the present invention will be described below with reference to the accompanying drawings. In the specification and the drawings, identical reference signs are assigned to components having substantially identical functions or configurations, whereby duplicate descriptions are omitted.

### One Embodiment

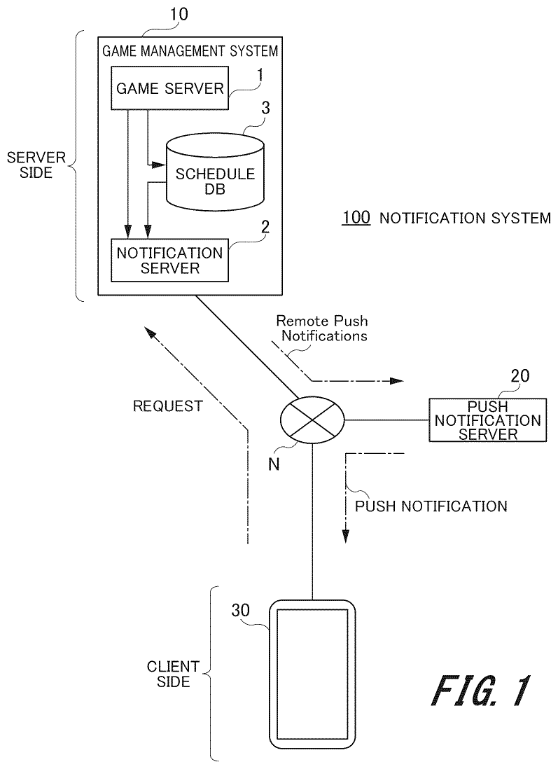

FIG. 1 is an overall configuration diagram showing the outline of a notification system 100 according to one embodiment.

The notification system 100 includes a game management system 10, a push notification server 20, and a client terminal 30. The game management system 10, the push notification server 20, and the client terminal 30 are connected to one another via a network N, such as the Internet, so that various kinds of data can be sent and received.

### <Client Terminal>

The client terminal 30 is an example of an electronic device operated by a user (not shown) and is capable of executing various types of apps. The client terminal 30 is assumed to be, for example, a smartphone, a tablet, or a PC (personal computer). Although there are various types of apps that are executed on the client terminal 30, in particular, a case where a game application program (hereinafter, referred to as “game app”) is executed will be described. Note that, when processing in the client terminal 30 is described, the client terminal 30 is referred to as “client side”, in some cases.

As the game app, there is a piece of idle content that gives rewards to the user according to an idle time during which the user does not perform an operation. Rewards that can be obtained by the user who has started the idle content are assumed to be a currency available in the idle content, items, characters that can be manipulated in the idle content, character level-up information, etc.

Note that the idle content may be a part of a piece of content included in the game app executed in the client terminal 30. On the client terminal 30 in the state in which the idle content is not displayed, a lock screen is displayed that restricts an input operation until the user is authenticated by an authentication function of the client terminal 30.

After the idle content is started, when the lock screen is displayed, the client terminal 30 displays information related to rewards on the lock screen. However, the information related to rewards may be displayed, for example, in a display area where idle-type content is not displayed. Furthermore, in the case where the game app is executed by a PC serving as the client terminal 30, when the PC is already activated, a display area where idle-type content is displayed may be provided, not on the entire display screen of the PC, but on a part of the display screen of the PC. Thus, when the PC is already activated, the information related to rewards may be displayed, for example, in one of the four corners of the display screen of the PC, as a display area where idle-type content is not displayed. Note that, the position of a display area where idle-type content is not displayed can be changed arbitrarily according to the specifications or control of the push notification server 20 or the OS (operating system) of the PC. Furthermore, the user may set the position of a display area where information related to rewards is displayed.

Here, rewards are obtained by the user after the idle content is started and include various achievements obtained by a character, such as in-game items, currency, experience points of the character, the number of enemies defeated by the character, a building built in the game, a dungeon level reached by the character, etc. Then, information related to rewards is notified to the user when push notifications are sent to the client terminal 30 via the push notification server 20. Thus, even when the lock screen is displayed, the user operating the client terminal 30 can see that the idle content has progressed and that rewards have been obtained according to the time during which the idle content is executed.

Furthermore, when the user checks the information related to rewards displayed on the lock screen, the user can also unlock the lock screen and play the game app of the idle content. A plurality of rewards may be notified, and, further, a staged reward may be provided. For example, if a reward is an item, after idle-type content is started, the number of rewards to be obtained may be increased over time, e.g., one item is obtained after one hour, and ten items are obtained after five hours. Alternatively, if a reward is a building, after idle-type content is started, the type of a reward to be obtained may be changed over time, e.g., a first floor will be built after one day, and a second floor will be built after two days. Such a staged reward will be described later together with screen display examples.

### <Game Management System>

The game management system 10 delivers various pieces of content to the client terminal 30 and manages game apps. Pieces of content used in the client terminal 30 include, for example, pieces of content used in game apps. Note that, when processing in the game management system 10 is described, the game management system 10 is referred to as “server side”, in some cases.

The game management system 10 includes a game server 1, a notification server 2, and a schedule DB (database) 3. When receiving a request to start the idle content, the game server 1 generates a schedule for giving rewards to the client terminal 30. A request to start the idle content is a request sent from the client terminal 30 when the idle content is started in the client terminal 30. Note that, when generating the schedule, the game server 1 also generate, for example, information for making the client terminal 30 draw or display the schedule and the rewards. At this time, it is also possible that the game server 1 only issues a drawing instruction to the client terminal 30, and images etc. of the content of the game app are drawn and displayed by the client terminal 30 that has received the drawing instruction.

According to the schedule generated by the game server 1, the notification server 2 sends a notification for displaying information related to rewards in a display area of the client terminal 30. Thus, the notification server 2 sends a notification to the client terminal 30 according to the schedule obtained from schedule data. For example, the notification time is scheduled like 10:05:00, and, when the current time reaches this scheduled time, a notification is sent to the client terminal 30. Note that this notification is a push notification sent to the client terminal 30 via the push notification server 20 when the notification server 2 sends “Remote Push Notifications” to the push notification server 20, as described later.

As described above, the lock screen is displayed on the client terminal 30. For example, in a partial area of the lock screen, rewards themselves or information for notifying that the user has obtained rewards is displayed as information related to rewards.

Schedule data containing the schedule generated by the game server 1 is stored in the schedule DB 3. The schedule DB 3 stores, for each user who uses the idle content, schedule data containing rewards and a schedule. After the idle content is started in the client terminal 30, the notification server 2 reads the schedule data from the schedule DB 3 and sends a notification of the rewards to the client terminal 30 used by the corresponding user, on the basis of the schedule data.

For notifications sent by the notification server 2, “Remote Push Notifications” are used. The “Remote Push Notifications” are data for push notifications. The notification server 2 can indirectly send push notifications to the client terminal 30 via the push notification server 20 by using “Remote Push Notifications”. In this way, processing of the notification server 2 for sending a push notification to the client terminal 30 via the push notification server 20 is also referred to as “notification”.

### <Push Notification Server>

The push notification server 20 is, for example, a server managed by the maker, i.e., the manufacturer, of the OS executed in the client terminal 30. When receiving “Remote Push Notifications” from the game management system 10, the push notification server 20 performs push notification with respect to the client terminal 30. The push notification server 20 restricts unwanted push notifications from third parties to the client terminal 30.

The push notification server 20 is also referred to as an APN/FCN server, for example. Note that the APN server is a push notification server managed by Apple Inc., and the FCN server is a push notification server managed by Google Inc. In the case where client terminals 30 are smartphones or the like, the smartphones all communicate regularly with push notification servers 20 managed by the manufacturers of the respective OSs and can receive push notifications via the push notification servers 20. Thus, an app created by a third party that is different from the manufacturers of the respective OSs sends requests to send push notifications, to the push notification servers 20. As a result, even though the game server of a third party does not know the IP addresses (Internet Protocol addresses) of the smartphones in advance, the game server can indirectly send push notifications to the smartphones via the push notification servers 20.

Here, an overview of processing in which the game management system 10 updates game information used in the game app including the idle content, by using a remote push notification will be described below. The remote push notification is a mechanism in which a third party sends a push notification to the client terminal 30 via the push notification server 20.

In the client terminal 30, if another app is started after the idle content is started, the game of the idle content is not played, so a background operation of the idle content is not performed. On the other hand, in the game server 1, after the idle content is started in the client terminal 30, game information is generated, and the game information is updated using a remote push notification to the client terminal 30 according to the schedule. The game information includes information of rewards etc. obtained by the user. Conventionally, the user activates the game app, performs a background operation of the idle content, and then checks rewards; however, in this embodiment, the user can check rewards without activating the game app. That is, when the user checks rewards, a background operation of the idle content is not required.

In this way, when the game management system 10 updates the game information in the client terminal 30 using a remote push notification, the client terminal 30 does not need to perform a background operation of the game app. Therefore, in this embodiment, at the start of the idle content in the client terminal 30, a “content result pre-generation function” of pre-generating reward results for this content on the server side is introduced. Content results pre-generated in the game management system 10 are sent to the client terminal 30 according to the schedule generated in the game management system 10 together with the content results. In this embodiment, “content results” become “reward results”. The reward results are specific instances generated individually for each user in the game server 1. Thus, rewards are given to the user on the basis of the reward results generated in the game server 1. In the following description, reward results and rewards are described while being treated the same in meaning, in some cases. Furthermore, generation of reward results, performed in the game server 1, may be described as generation of rewards, in some cases. In order for the game management system 10 to realize a function of giving rewards to the user, the following functions 1 to 3 are required.

Function 1: when the idle content is started, the game app in the client terminal 30 sends a request to start the idle content to the game server 1 of the server side.

Function 2: when accepting the request to start the idle content, the game server 1 of the server side generates reward results for this content and schedules the times to send “Remote Push Notifications” containing the reward results.

Function 3: after the scheduling performed by the game server 1, the notification server 2 periodically sends “Remote Push Notifications” to the client terminal 30 via the push notification server 20, to make push notifications.

### <Explanation of Real-Time Notification Function>

Here, a real-time notification function will be described.

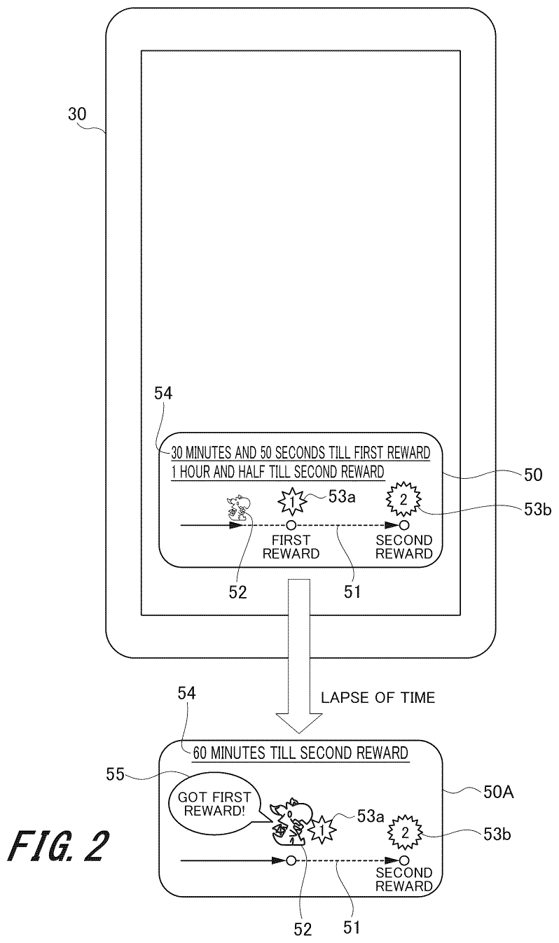

FIG. 2 is a view showing a display example (1) of a reward notification screen overlaid on the lock screen of the client terminal 30 in the notification system 100.

The real-time notification function of the client terminal 30 is a function that enables widgets, which are customizable for individual apps, to be displayed on the lock screen shown in FIG. 2. In application examples other than the game in this embodiment, various pieces of real-time information in the real world, such as delivery waiting time from a delivery app and match scores from a live sports app, are displayed on the lock screen, which is displayed before authentication.

Normally, in the above application examples, it is assumed that a notification of an event that occurs in the real world, i.e., a real event, is sent to the client terminal 30. As a real-event notification, for example, in a delivery service, the current location of a delivery vehicle is notified to the client terminal 30 every predetermined time. In the real-event notification, it is impossible to implement the “content result pre-generation function” of Function 2. This is because it is impossible to determine in advance at what time and at what location the delivery vehicle will pass through.

On the other hand, with the game management system 10 of this embodiment, real-time update in which the lock screen displayed on the client terminal 30 is updated is possible by performing the above processing in the order of Function 1 to Function 3. Here, the real-time update is to display a reward provided to the user on the lock screen every real time scheduled from the start time at which the idle content is started. As shown in FIG. 2, with the game management system 10, information related to rewards for the idle content, the information being generated on the server side, is displayed on the lock screen. That is, information displayed on the lock screen is not various pieces of real-time information in the real world but is information generated by the game server 1. In this way, the user of the client terminal 30 starts the idle content, whereby rewards are generated in advance by the game server 1. This is different from an app that aims to notify a real event using the real-time notification function.

On the lock screen of the client terminal 30, rewards themselves (for example, the currency obtained in the game) obtained by a character after the idle content is started are displayed as information related to rewards. Furthermore, on the lock screen, information that does not directly state rewards (for example, information indicating that the currency has been obtained in the game) can also be displayed as information related to rewards.

Here, reward notification screens 50 and 50A will be described with reference to FIG. 2. The reward notification screens 50 and 50A are screens displayed in a partial area of the lock screen and are used to notify the user of rewards obtained by a character 52 in the game. As described above, although the user obtains rewards over time after the idle content is started, here, a description will be given of a case in which the character 52 obtains rewards.

The reward notification screen 50 shows a state in which the character 52 moves toward a first reward icon 53a and a second reward icon 53b that are provided in a time chart 51 starting from left to right. For the first reward icon 53a, it is indicated that the number of rewards obtained by the character 52 is “1”, and a reward name “first reward” is given. Furthermore, for the second reward icon 53b, it is indicated that the number of rewards obtained by the character 52 is “2”, and a reward name “second reward” is given. Here, as the rewards, for example, items that can be obtained by the character 52 are assumed. After the idle content is started, as the idle time increases, the character 52 obtains the first reward and the second reward in this order. The times required to obtain the first reward and the second reward are scheduled by the game server 1 from the start time at which the idle content is started.

In a reward acquisition time display area 54 provided in an upper section of the reward notification screen 50, times required for the character 52 to obtain the respective rewards are displayed. For example, the reward acquisition time display area 54 shows that the character 52 takes “30 minutes and 50 seconds” to obtain the first reward and takes “one and a half hours” to obtain the second reward. By checking the times required to obtain the respective rewards, the user can see how long it takes for the character 52 to obtain the rewards. Then, the idle time that has elapsed since the start of the idle content is expressed by the line type changed from a dashed line to a solid line when the character 52 moves from a left end of the time chart 51 toward right. Then, when the character 52 reaches the first reward icon 53a, it is visually expressed that the character 52 obtains the first reward, and, when the character 52 reaches the second reward icon 53b, it is visually expressed that the character 52 obtains the second reward.

The fact that the character 52 has obtained the first reward is indicated by transition from the reward notification screen 50 to the reward notification screen 50A. The reward notification screen 50A is displayed in the partial area of the lock screen, instead of the reward notification screen 50. In a left section of the reward notification screen 50A, a speech bubble icon 55 showing “I got the first reward!” said by the character 52 is displayed. The user can see that the character 52 has obtained the first reward, by viewing the speech bubble icon 55.

Note that, in the game management system 10, which manages the game content, notification of a real event is not required, and content results are generated in advance at the start of the idle content. Thus, the “content result pre-generation function” of Function 2 is implemented in the game management system 10, whereby content results can be generated in advance at the start of the idle content, and a reward(s) or a related piece of content can be provided to the user of the idle content every scheduled time.

Thus, when the lock screen is updated on the server side, “Remote Push Notifications” are used. However, when the game app is operated in the client terminal 30 (i.e., during gameplay), notification scheduling of the “Remote Push Notifications” for the idle content is stopped. When notification scheduling of the “Remote Push Notifications” is stopped, if a certain notification is sent from the game server 1 to the client terminal 30, an instruction to send the “Remote Push Notifications” is output to the notification server 2 not through the schedule DB 3.

When the lock screen is updated on the game app side, it is desired that information is updated by a local app built in the client terminal 30. The reason for this is that information related to rewards notified by the notification server 2 is displayed on the lock screen, and the lock screen is not displayed when the game app is operated in the client terminal 30.

### <Example Hardware Configuration of Game Server>

Next, an example hardware configuration of the game server 1 will be described.

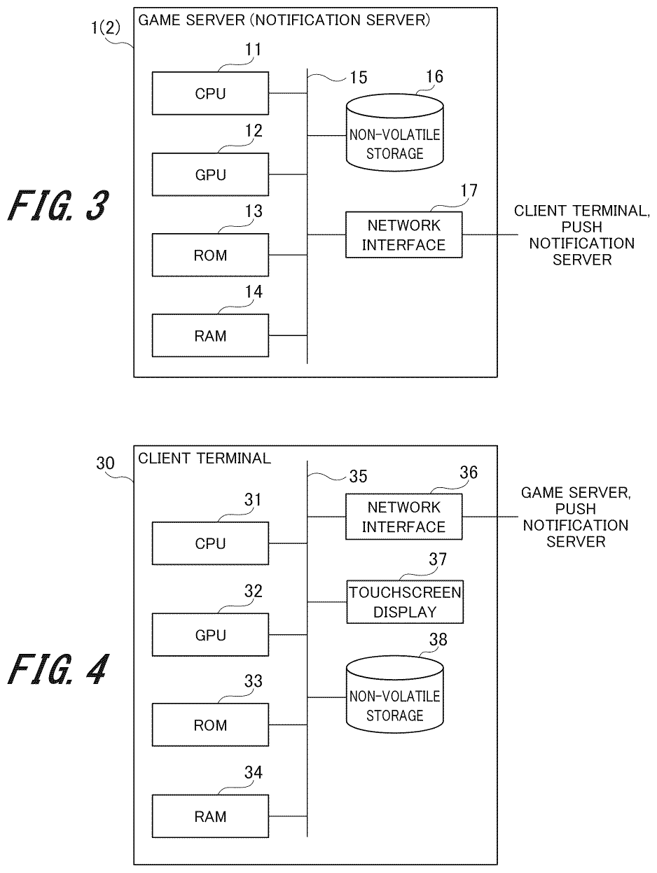

FIG. 3 is a block diagram showing an example hardware configuration of the game server 1 in the notification system 100. Note that, since an example hardware configuration of the notification server 2 is the same as that of the game server 1, only the example hardware configuration of the game server 1 will be described.

### (Example Configuration of Game Server)

The game server 1 is an example of a calculator operated as a computer. The game server 1 includes a CPU (Central Processing Unit) 11, a GPU (Graphics Processing Unit) 12, a ROM (Read Only Memory) 13, a RAM (Random Access Memory) 14, a non-volatile storage 16, and a network interface 17 that are individually connected to a bus 15.

The CPU 11 reads, from the ROM 13, program code of software that realizes each of the functions of this embodiment, loads the program code into the RAM 14, and executes the program code. The GPU 12 performs, for example, processing required to draw a 3D object on the screen. Variables, parameters, etc., generated in the middle of arithmetic processing of the CPU 11 or the GPU 12 are temporarily written to the RAM 14, and these variables, parameters, etc., are read by the CPU 11 or the GPU 12 as appropriate.

As the non-volatile storage 16, for example, an HDD (Hard Disk Drive), an SSD (Solid State Drive), an optical disk, a magneto-optical disk, a CD-ROM, a magnetic tape, a non-volatile memory, or the like is used. The non-volatile storage 16 has recorded, in addition to the OS of the game server 1 and various kinds of parameters, programs for making the game server 1 function. The ROM 13 and the non-volatile storage 16 have recorded programs, data, etc., that are necessary for the CPU 11 to operate, and are each used as an example of a computer-readable non-transitory recording medium that has stored programs executed by the game server 1.

For example, a NIC (Network Interface Card) or the like is used as the network interface 17, and various kinds of data can be sent and received to and from the client terminal 30 via a LAN (Local Area Network), a dedicated line, or the like connected to a terminal of the NIC. As shown in FIG. 1, through the network interface 17, the game server 1 can be connected to the push notification server 20 and the client terminal 30 via the network N.

### <Example Hardware Configuration of Client Terminal>

Next, an example hardware configuration of the client terminal 30 will be described.

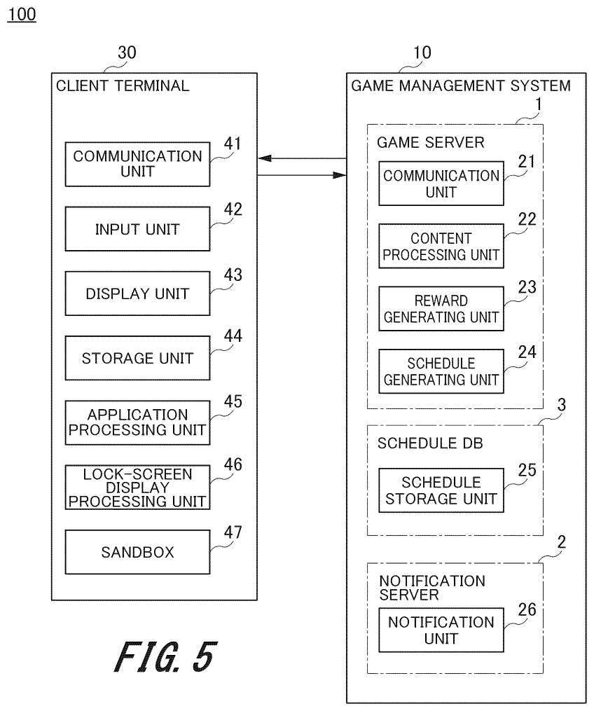

FIG. 4 is a block diagram showing an example hardware configuration of the client terminal 30 in the notification system 100.

The client terminal 30 is an example of a calculator operated as a computer capable of executing various kinds of programs. The client terminal 30 includes a CPU 31, a GPU 32, a ROM 33, a RAM 34, a network interface 36, a touchscreen display 37, and a non-volatile storage 38 that are individually connected to a bus 35.

The CPU 31 reads, from the ROM 33, program code of software that realizes each of the functions of the client terminal 30, loads the program code into the RAM 34, and executes the program code. Variables, parameters, etc., generated in the middle of arithmetic processing of the CPU 31 or the GPU 32 are temporarily written to the RAM 34, and these variables, parameters, etc., are read by the CPU 31 or the GPU 32 as appropriate. The CPU 31 performs processing of the OS of the client terminal 30 and processing of management of data input and output performed in the individual units in the client terminal 30.

The GPU 32 performs, for example, processing required to draw a 3D object on the touchscreen display 37.

For example, a NIC (Network Interface Card) or the like is used as the network interface 36, and various kinds of data can be obtained and can be sent and received to and from another client terminal 30 via a LAN (Local Area Network), a dedicated line, or the like connected to a terminal of the NIC.

The touchscreen display 37 is an example of an input/output device in which a display surface and an operation surface are integrated. The touchscreen display 37 generates an operation signal on the basis of the coordinates of the position operated on the operation surface and passes the operation signal to the CPU 31. Furthermore, the touchscreen display 37 outputs a video based on data of the screen drawn by the CPU 31 or the GPU 32, to the display surface.

As the non-volatile storage 38, for example, an HDD, an SSD, a flexible disc, an optical disk, a magneto-optical disk, a CD-ROM, a non-volatile memory, or the like is used. The non-volatile storage 38 has recorded, in addition to the OS and various kinds of parameters, programs for making the client terminal 30 function. The ROM 33 and the non-volatile storage 38 have recorded programs, data, etc., that are necessary for the CPU 31 or the GPU 32 to operate, and are each used as an example of a computer-readable non-transitory recording medium that has stored programs executed by the client terminal 30.

Note that the client terminal 30 includes a camera, a microphone, a speaker, a battery, etc., in addition to the hardware shown in FIG. 4. Furthermore, if the client terminal 30 is a PC, the client terminal 30 includes a keyboard and a mouse serving as input devices and a liquid crystal display monitor or the like serving as a display device.

### <Example Functional Configurations of Game Management System and Client Terminal>

Next, example functional configurations of the game management system 10 and the client terminal 30 will be described.

FIG. 5 is a block diagram showing example functional configurations of the game management system 10 and the client terminal 30 in the notification system 100. In FIG. 5, a block diagram showing an example functional configuration of the push notification server 20, which is shown in FIG. 1, is omitted.

### (Example Functional Configuration of Game Management System)

First, an example functional configuration of the game management system 10 will be described. The game server 1 of the game management system 10 includes a communication unit 21, a content processing unit 22, a reward generating unit 23, and a schedule generating unit 24.

The communication unit 21 performs communication processing for providing, to the client terminal 30, data etc. obtained in response to an acquisition request issued from the game app executed in the client terminal 30. Furthermore, when the client terminal 30 starts the idle content, the communication unit 21 receives a request to start the idle content sent from the client terminal 30. The function of the communication unit 21 is realized by the network interface 17, which is shown in FIG. 3.

The content processing unit 22 performs processing of pieces of content executed in the client terminal 30. The pieces of content processed in the client terminal 30 also include, in addition to the idle content, pieces of content that require operations of the user. Thus, when the communication unit 21 receives, from the client terminal 30, information about an operation input to the client terminal 30 performed by the user, the content processing unit 22 performs content processing on the basis of the information about the operation. The result of the content processing performed by the content processing unit 22 is sent to the client terminal 30 via the network N by the communication unit 21.

The reward generating unit 23 generates rewards when the communication unit 21 receives a request to start the idle content. The rewards generated by the reward generating unit 23 mean “reward results” that are the above-described instances. At the timing when the request to start the idle content is received, the reward generating unit 23 collectively generates rewards and display content displayed on the client terminal 30 every notification time specified in advance from the start time of the idle content. The notification time may be changed according to the level of the user who uses the idle content. Note that rewards such as items, leveling up, etc., are linked to each user in a reward DB (not shown) and given.

When the reward generating unit 23 generates rewards, the schedule generating unit 24 generates a schedule for the notification server 2 to send “Remote Push Notifications”. Here, the schedule generating unit 24 generates a schedule in which timings of sending notifications from the notification server 2 every notification time are specified.

The schedule DB 3 includes a schedule storage unit 25.

The schedule storage unit 25 stores, for each user, schedule data generated by the schedule generating unit 24. The schedule data contains the timings of sending notifications and information about rewards to be given to the user at the timings of sending the notifications.

The notification server 2 includes a notification unit 26.

The notification unit 26 reads the schedule data from the schedule storage unit 25. Then, the notification unit 26 sends “Remote Push Notifications” to the push notification server 20 according to the schedule obtained from the schedule data.

### (Example Functional Configuration of Client Terminal)

The client terminal 30 includes a communication unit 41, an input unit 42, a display unit 43, a storage unit 44, an application processing unit 45, a lock-screen display processing unit 46, and a sandbox 47.

The communication unit 41 sends data etc. used in the game app operated by the user, to the game management system 10. Furthermore, the communication unit 41 can also receive update data for upgrade of the game app from the game management system 10.

Furthermore, when the idle content is started in the client terminal 30, the communication unit 41 sends a request to start the idle content to the game management system 10. Furthermore, the communication unit 41 receives rewards for the idle content notified by push notifications via the push notification server 20. The function of the communication unit 41 is realized by the network interface 36, which is shown in FIG. 4.

The input unit 42 outputs an operation signal generated therein on the basis of an operation input by the user, to the application processing unit 45.

The display unit 43 displays an image processed by the application processing unit 45, on the basis of the operation signal generated in the input unit 42. Images to be displayed include moving images and still images.

The functions of the input unit 42 and the display unit 43 are realized by the touchscreen display 37, which is shown in FIG. 4.

The storage unit 44 stores the idle content used in the client terminal 30. As described above, the idle content is the game app itself or a part of a piece of content included in the game app. Furthermore, the storage unit 44 stores rewards notified from the game management system 10 when the idle content is started.

The application processing unit 45 performs processing of various types of apps. In this embodiment, it is assumed that the application processing unit 45 performs processing of an app related to the idle content. When the idle content is started, the application processing unit 45 instructs the communication unit 41 to send a request to start the idle content.

The lock-screen display processing unit 46 is a client-side module for displaying the game status stored in a push notification received via the push notification server 20, on the lock screen according to the specifications of the OS of the client terminal 30. The lock-screen display processing unit 46 performs processing for displaying the lock screen on the display unit 43, when an input to the client terminal 30 is restricted by the lock function.

Then, when the communication unit 41 receives a push notification that has stored rewards from the notification server 2 via the push notification server 20, the lock-screen display processing unit 46 performs processing for displaying information related to the rewards in a partial area of the lock screen. The lock-screen display processing unit 46 is realized by using a live activity function provided by Apple Inc., for example.

The sandbox 47 has a function of restricting the behaviors of various kinds of apps for privacy protection and security. The lock-screen display processing unit 46 is a function executed in the sandbox 47 used to display the lock screen.

Here, the real-time notification function will be described again.

The client terminal 30 displays, on the lock screen, the progress status of the idle content in real time by using the real-time notification function. The real-time notification function is realized by using a function of allowing an app of a third party to update a notification on the lock screen in real time. Unlike apps or widgets, the real-time notification function is characterized in that it is executed in the independent sandbox 47 and updates information using a remote push notification. Thus, the real-time notification function has a function of displaying and updating the latest data of the app on the lock screen.

### <Processing in Client Side and Server Side>

Next, example processing in the client side and the server side will be described.

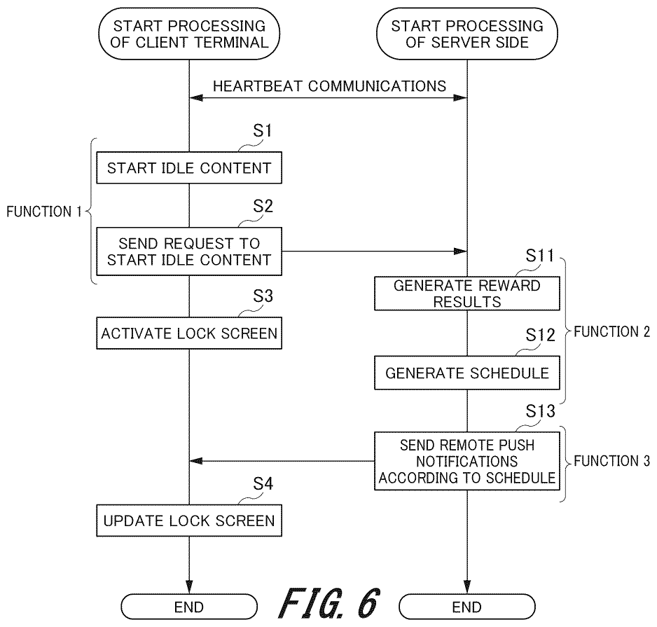

FIG. 6 is a sequence diagram showing example processing in the client side and the server side in the notification system 100. The content of the processing will be described together with the functional units shown in FIG. 5.

In general, while a game app is being operated in the client terminal 30 (while a game is being played), data indicating that the game is being played is constantly sent to the game server 1. Such processing for constantly sending data to the game server 1 is called heartbeat, which is likened to the beating of the heart.

The functional roles are divided between the server side and the client side, as follows.

The server side performs: various arithmetic processing procedures related to the game; and storage and management of master data of the status, items, etc., of each user. That is, information for enabling the user to smoothly play the game is managed on the server side.

On the other hand, the client side performs: storage of drawing information of a 3D model and a display screen; and screen display processing based on the drawing information. The drawing processing and the display processing for the display screen are performed on the client side, whereby the processing load on the server side can be reduced.

However, the division of the functions between the server side and the client side is not limited to the above example. Various arithmetic processing procedures related to the game may be performed on the client side. Furthermore, a 3D model and a display screen drawn on the server side may be directly displayed on the display device (the touchscreen display 37, a monitor, or the like) on the client side.

Note that, as one example of this embodiment, in the case where the user is playing the game, i.e., while the heartbeat is exchanged between the game app and the game server 1, transmission of push notifications may be turned off at the game server 1. Thus, information sent by push notifications is not overlaid on the screen during the gameplay.

Next, processing procedures of the above-described Function 1 to Function 3, which are unique to the game management system 10, will be described in this order.

### (Function 1)

First, when the user instructs to start the idle content in the game played in the client terminal 30, the application processing unit 45 starts the idle content (S1). Next, the application processing unit 45 sends a request to start the idle content to the game server 1 (S2). The request is sent from the communication unit 41 of the client terminal 30 to the network N. Then, the communication unit 21 of the game server 1 receives the request to start the idle content.

After Step S2, the lock-screen display processing unit 46 displays the lock screen. Then, the lock-screen display processing unit 46 is implemented in the client terminal 30 as software capable of receiving only “Remote Push Notifications” sent via the push notification server 20.

### (Function 2)

The game server 1, which is shown in FIG. 1, is a server-side module that generates reward results for the idle content and that schedules “Remote Push Notifications” containing the reward results. When the communication unit 21 of the game server 1 receives the request to start the idle content sent in Step S2, the reward generating unit 23 pre-generates reward results for the idle content (S11). Next, the schedule generating unit 24 generates a schedule for sending “Remote Push Notifications” to the push notification server 20, in order to provide the rewards to the user.

Here, when the idle content is started in the client terminal 30, the reward generating unit 23 generates, as reward results, items, parameters such as experience points and in-game currency, or the like that the user can obtain as rewards during the total time (for example, six hours) of the idle content. Then, the schedule generating unit 24 makes a list of the reward results generated by the reward generating unit 23 while linking the reward results to times at which the user can obtain the reward results.

For example, when push schedule data generated by the game server 1 in response to a request to start the idle content sent from a user k (the client terminal 30) is called Sₖ, Sₖ can be defined as the following Equation (1).

Sₖ:=[sᵢ(tᵢ,rᵢ),sᵢ₊₁(t₁,rᵢ₊₁), . . . sᵢ₊ₙ(t_{+n i},rᵢ₊ₙ)] (1)

In Equation (1), sᵢ(tᵢ, rᵢ) indicates i-th reward information, tᵢ indicates time at which acquisition of a reward should be notified, and rᵢ indicates specific reward information. For example, tᵢ is expressed as time one hour later, three hours later, or six hours later, starting from the time at which the idle content is started. Equation (1) expresses that, after the idle content is started, when the current time becomes tᵢ, the user k is notified that the user k has obtained rᵢ.

A collection of pieces of the above-described push schedule data is stored in the schedule DB 3. In the schedule DB 3, although it is generally preferred that a relational database is used to store the collection of pieces of the push schedule data, a Key-Value storage that is one kind of a non-relational database may be used.

### (Function 3)

The notification server 2 is a server-side module that regularly sends “Remote Push Notifications” stored in the schedule DB 3 to the client terminal 30 via the push notification server 20. Although not shown in FIG. 6, the “Remote Push Notifications” are sent to the push notification server 20, and then push notification is performed on the client terminal 30 via the push notification server 20.

In the above-described game management system 10 of the embodiment, the real-time notification function is used in the game app including the idle content etc. Then, the status of the game app including the idle content etc. is updated and displayed in real time on the lock screen displayed on the client terminal 30. Thus, the user who has checked the status of the game app can efficiently confirm visually the progress status of the idle content without unlocking the lock screen and can be strongly motivated to play the game more. Furthermore, since the progress status of the idle content is notified according to the schedule, it is possible to strongly motivate the user to unlock the lock screen and to play the game, at a user's convenient timing.

If notification of game information is performed in real time, an operation of the game app must be executed on the server side or the client side in accordance with the period of time during which the client terminal 30 displays the lock screen. However, the game server 1 in the notification system 100 of this embodiment automatically calculates rewards and a display plan therefor, when a request to start the idle content is received from the client terminal 30. Then, after automatically calculating the rewards, the game server 1 just sends “Remote Push Notifications” to the push notification server 20 in accordance with the scheduled times, thereby enabling push notifications for giving the rewards to the user. Thus, since it is not necessary to make the game server 1 run for several hours in accordance with the operation time of the idle content used by a single user, the game server 1 can perform processing for giving rewards, for the use of the idle content, to a large number of users easily and efficiently and with low load.

Conventionally, users of a game app often turn off notifications of the game app to the lock screen. On the other hand, in the notification system 100 of this embodiment, since the progress status of the idle content, including rewards obtained by starting the idle content, is notified on the lock screen, users are easily motivated to turn on notifications of the game app to the lock screen. As a result, it is possible to strongly motivate the users to play the game.

The information related to rewards for the idle content displayed on the lock screen is not obtained when the client terminal 30 itself makes the game progress but is sent through push notification via the push notification server 20. Thus, in the client terminal 30, since there is no need to make the idle content run in the background after the idle content is started, battery consumption in the client terminal 30 can be reduced. Furthermore, the processing load of the server can be reduced.

Furthermore, while the lock screen is not displayed on the client terminal 30, transmission of “Remote Push Notifications” based on the schedule from the notification server 2 is stopped, and push notification of information related to rewards with respect to the client terminal 30 is stopped. Thus, it is possible to suppress the transmission costs of notifications (unnecessary-data transmission processing etc.) on the server side and the receiving costs of notifications (unnecessary-data receiving processing etc.) on the client terminal 30. Furthermore, the processing load of the server can be reduced.

### [Various Display Examples of Reward Notification Screen]

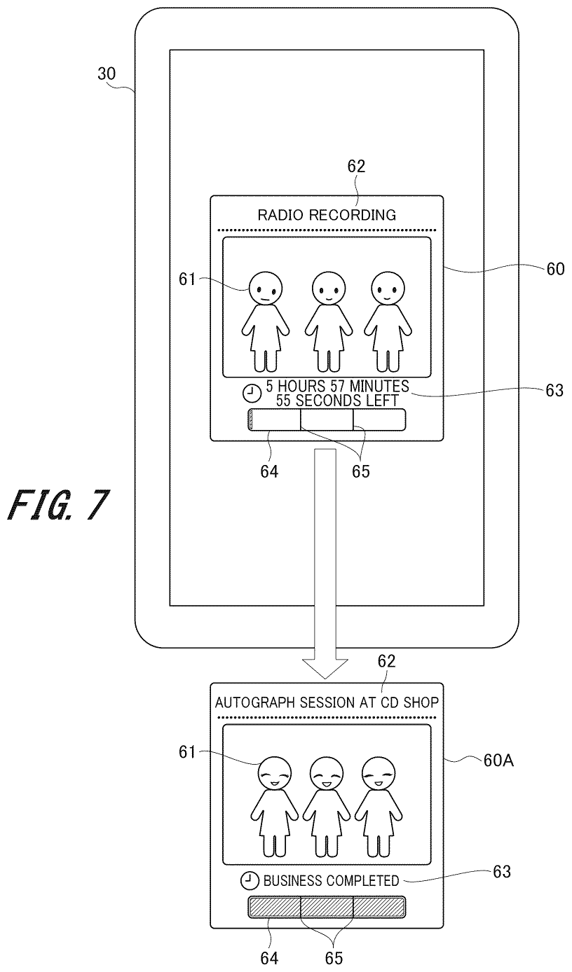

Note that, in addition to the reward notification screen shown in FIG. 2, various forms of reward notification screens can be conceived. Here, various display examples of a reward notification screen will be described with reference to FIGS. 7 to 9.

FIG. 7 shows a display example (2) of a reward notification screen overlaid on the lock screen of the client terminal 30. Here, reward notification screens 60 and 60A will be described. The reward notification screens 60 and 60A are screens that are displayed in a partial area of the lock screen and in which rewards to be obtained by a character 61 when the character 61 goes to a different place in the game after the start of the idle content are notified to the user.

An event title 62 is displayed in an upper section of the reward notification screen 60, and the character 61 in the idle content is displayed in a central section thereof. Furthermore, in a lower section of the reward notification screen 60, a remaining time 63 required for the character 61 to complete jobs (for example, business) is displayed, and a gauge 64 serving as an indication that the character 61 is to obtain rewards is further displayed. In the gauge 64, lines 65 are displayed that divide the gauge 64 into three periods of time, i.e., 2-hour time units, in each of which the character 61 obtains a reward. After the user starts the idle content, a color area in the gauge 64 increases from the left side over the elapse of the idle time. When the color area reaches each of the lines 65 in the gauge 64, the character 61 obtains a reward at that point. For example, every time 2 hours of the idle time elapses, the character 61 obtains a reward according to the idle time.

The fact that the character 61 has completed the jobs is indicated by transition from the reward notification screen 60 to the reward notification screen 60A. The reward notification screen 60A is displayed in the partial area of the lock screen, instead of the reward notification screen 60. When the idle time of six hours has elapsed after the start of the idle content, the gauge 64 is all filled up with the color area, which indicates that the jobs are all completed. Then, completion of all the jobs shows all rewards obtained by the character 61.

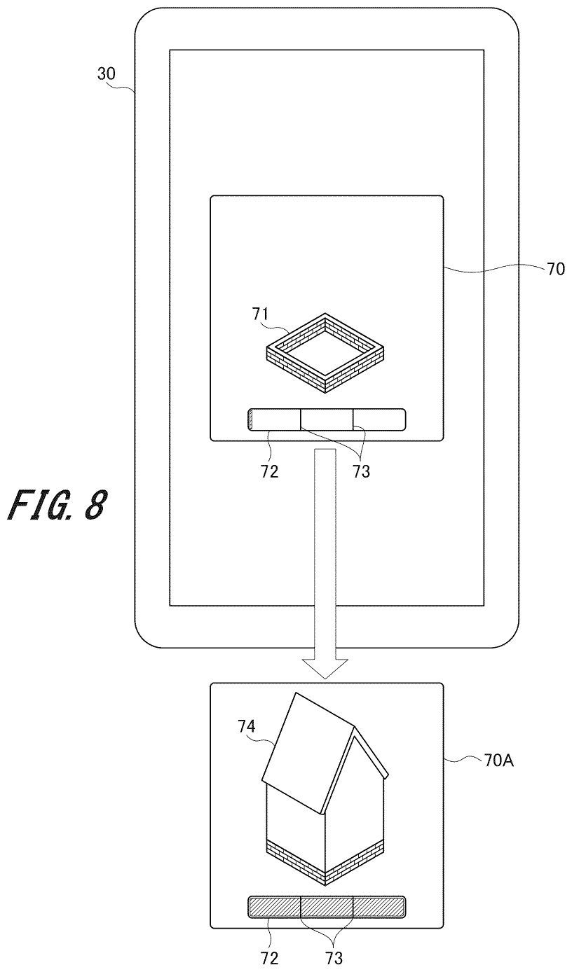

FIG. 8 shows a display example (3) of a reward notification screen overlaid on the lock screen of the client terminal 30. Here, reward notification screens 70 and 70A will be described. The reward notification screens 70 and 70A are screens that are displayed in a partial area of the lock screen and in which changes in the construction state of a building 71 after the start of the idle content are notified to the user as rewards.

A foundation of the building 71 is displayed in a central section of the reward notification screen 70, and a gauge 72 is displayed in a lower section of the reward notification screen 70. In the gauge 72, lines 73 are displayed that divide the gauge 72 into three periods of time, i.e., 1-day time units, in each of which the construction state of the building 71 progresses. After the user starts the idle content, a color area in the gauge 72 increases from the left side over the elapse of the idle time. Every time the color area reaches each of the lines 73 in the gauge 72, a progression of the construction state of the building 71 is obtained as a reward. For example, the user obtains, as a reward, an increase in the number of stories of the building 71 every time one day of the idle time elapses.

The fact that the construction of the building 71 has been completed is indicated by transition from the reward notification screen 70 to the reward notification screen 70A. The reward notification screen 70A is displayed in the partial area of the lock screen, instead of the reward notification screen 70. When the idle time of three days has elapsed after the start of the idle content, the gauge 72 is all filled up with the color area, which indicates that the construction is all completed. Then, a building 74 obtained after completion of all the construction shows all rewards obtained by the user.

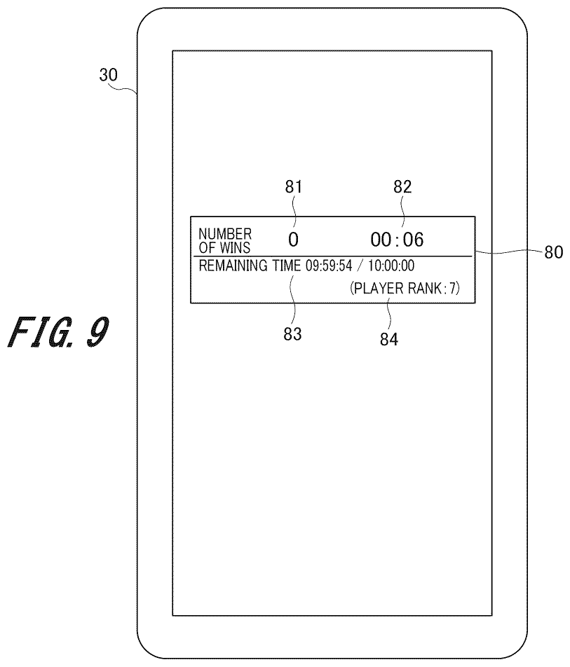

FIG. 9 shows a display example (4) of a reward notification screen overlaid on the lock screen of the client terminal 30. Here, a reward notification screen 80 will be described. The reward notification screen 80 is a screen that is displayed in a partial area of the lock screen and in which, after the start of the idle content, the number of times a player in a game automatically fights and wins against an enemy player is notified to the user as a reward. Here, the player in the game is a character (not shown) operated by the user who uses the client terminal 30.

A win count 81 of the player and an elapsed time 82 after the start of the idle content are displayed in an upper section of the reward notification screen 80. For example, it is assumed that the player wins once in a minute. The elapsed time 82 is obtained by subtracting the remaining time from the total time. The total time is the maximum time during which the reward can be obtained after the start of the idle content.

A remaining time 83 and a rank 84 of the player are displayed in a lower section of the reward notification screen 80. The remaining time 83 is expressed in the form of remaining time/total time.

In this way, as a result of a combat simulation performed in the game server 1, the win count 81 of the player shows the reward obtained in the idle content.

### OTHER MODIFICATIONS

Note that a piece of content of which information is displayed on the lock screen is not limited to the idle content. For example, a wide range of applications are conceivable, e.g., as the status of the game content, a conventionally performed function of displaying a message for celebrating a birthday from a character to a user or displaying a message of an event to be held in a predetermined date and time is displayed on the lock screen in combination with the idle content. For example, if it is the birthday of the user or the date of an event, the size of a reward is increased or the time required to obtain a reward is shortened, thereby making it possible to strongly motivate the user to play the game on his/her birthday.

Furthermore, although a smartphone including the touchscreen display 37 is used as the above-described client terminal 30, it is also possible to use a tablet terminal or a PC in which an input unit(s) (a mouse, a keyboard, etc.) and a display unit (a display device) are provided as separate units.

Furthermore, when the state of the client terminal 30 is changed to an offline state after the idle content is started, the client terminal 30 cannot receive push notifications via the push notification server 20. Thus, after the game server 1 detects that the state of the client terminal 30 is changed to the online state, rewards that could not be push-notified to the client terminal 30 according to the schedule due to the offline period may be included in one “Remote Push Notification” and collectively push-notified to the client terminal 30.

Furthermore, after the client terminal 30 starts the idle content, although information related to rewards is displayed on the lock screen according to the schedule, information related to rewards may be displayed on a screen other than the lock screen or in a display area (for example, four corners of a PC display screen). Furthermore, when another app is running, information related to rewards may also be overlaid on the screen on which the content of said another app is displayed.

Furthermore, after a certain time after the idle content is started, the client terminal 30 may also perform pull notification for prompting the push notification server 20 to notify rewards. It is possible that, after receiving a pull notification, the push notification server 20 sends data containing rewards to the client terminal 30 that has performed the pull notification, and information related to the rewards is displayed on the lock screen of the client terminal 30.

Note that the present invention is not limited to the above-described embodiment, and it is a matter of course that various other application examples and modifications can be made without departing from the gist of the present invention set forth in the scope of claims.

For example, in the above-described embodiment, the configurations of the terminal and the system have been described in detail and specifically in order to clearly describe the present invention; however, the present invention is not necessarily limited to the embodiment including all the configurations described above. Furthermore, for some of the configurations in this embodiment, addition of another configuration, deletion, or replacement can be made.

Furthermore, control lines and information lines that are considered to be necessary for explanation are shown, and not all control lines and information lines in products are shown. In fact, it may be considered that almost all configurations are interconnected.

### REFERENCE SIGNS LIST

1: game server, 2: notification server, 3: schedule DB, 10: game management system, 20: push notification server, 21: communication unit, 22: content processing unit, 23: reward generating unit, 24: schedule generating unit, 25: schedule storage unit, 26: notification unit, 30: client terminal, 41: communication unit, 42: input unit, 43: display unit, 44: storage unit, 45: application processing unit, 46: lock-screen display processing unit, 47: sandbox, 100: notification system

What is claimed is:

1. A notification system comprising:
a game server that generates, when a piece of idle content for giving a reward to a user in accordance with an idle time during which an operation is not performed is started in an electronic device, a schedule for giving the reward; and
a notification server that performs notification for displaying information related to the reward in a display area of the electronic device, according to the schedule.

2. A notification system according to claim 1, wherein the notification server stops the notification when the idle content is displayed on a screen of the electronic device.

3. A notification system according to claim 2, further comprising a schedule DB that stores, for the user, schedule data containing the reward and the schedule,
wherein the notification server performs the notification according to the schedule obtained from the schedule data.

4. A notification system according to claim 3, wherein the game server has:
a communication unit that receives a request to start the idle content sent from the electronic device after the electronic device starts the idle content;
a reward generating unit that generates the reward when the request to start the idle content is received by the communication unit; and
a schedule generating unit that generates the schedule when the reward is generated.

5. A notification system according to claim 4,
wherein the reward generating unit generates the reward in each notification time, specified in advance, from the start time of the idle content, and
the schedule generating unit generates the schedule in which the timing to perform the notification in said each notification time is specified.

6. A notification system according to claim 1,
wherein a lock screen on which an input operation is restricted is displayed on the electronic device in the state in which the idle content is not displayed, and
information related to the reward is displayed on the lock screen.

7. A notification system according to claim 6, wherein the idle content is a game application program itself executed in the electronic device.

8. A notification system according to claim 6, wherein the idle content is a part of a piece of content included in a game application program executed in the electronic device.

9. A notification method executed in a notification system including a game server and a notification server, the method comprising:
a step in which the game server generates, when a piece of idle content for giving a reward to a user in accordance with an idle time during which an operation is not performed is started in an electronic device, a schedule for giving the reward; and
a step of performing notification for displaying information related to the reward in a display area of the electronic device, according to the schedule.
